(19) United States
(12) Patent Application Publication
(10) Pub. No.: US 2023/0219866 A1
(43) Pub. Date: Jul. 13, 2023

(54) GAS GENERATING COMPOSITIONS AND METHODS OF USING

(71) Applicant: JOYSON SAFETY SYSTEMS ACQUISITION LLC, Auburn Hills, MI (US)

(72) Inventors: Deborah Hordos, Troy, MI (US); Sudhakar Ganta, Troy, MI (US)

(21) Appl. No.: 18/148,637

(22) Filed: Dec. 30, 2022

Related U.S. Application Data
(60) Provisional application No. 63/295,670, filed on Dec. 31, 2021.

(51) Int. Cl. C06D 5/06

(52) U.S. Cl. CPC C06D 5/06; B60R 21/2644

(57) ABSTRACT

Gas generating compositions according to various implementations comprise an oxidizer comprising a metal nitrate. A secondary oxidizer may be used and can be chosen from alkali metal and alkaline earth metal salts of perchloric acid. The gas generating compositions also comprise a fuel selected from tetrazoles and tetrazole derivatives. A secondary fuel may be used and can be a nitrogen containing organic compound or a metal carbide. Optionally, the gas generating compositions may comprise additional additives.

### TECHNICAL FIELD

The present disclosure relates to safety devices for passenger vehicles. In particular, the disclosure relates to gas generating compositions for use in airbag inflators.

### BACKGROUND

Airbag systems have been widely adopted for improving the safety of passengers in vehicles, such as automobiles. In these systems, a gas generator is operated by ignition signals from a crash sensor detecting a collision and inflates an airbag between a passenger and a portion of the automobile. The gas generator is required to produce a sufficient amount of gas to inflate the airbag in a very short time.

The gas generating compositions used to generate gas in current gas generators contain, at least, an oxidizer and a fuel. The particular components used in a given composition, and the amount of these components, greatly affects the properties (e.g., ignition rate, burn rate, heat, sensitivity, etc.) and thus the suitability of a composition for inflating an airbag.

Gas generating compositions for use in airbag gas generators include, but are not limited to, main gas generating compositions and booster gas generating compositions. Main gas generating compositions provide the bulk of the inflation gas for inflating the airbag. Booster gas generating compositions provide the proper amount of heat, gas, and particulates for igniting the main gas generating composition upon receiving the ignition signal. Depending on the ignition properties of the main gas generating composition, some booster gas generating compositions are more or less suitable for use with a given main gas generating composition. As a result, it is important to tune the booster gas generating composition for use with a given main gas generating composition to achieve the overall goals of the gas generator and airbag system.

### SUMMARY

Various implementations include gas generating compositions for use in airbag gas generators. The gas generating compositions may comprise from 36 to 65% by weight of a primary oxidizer selected from the group consisting of a metal nitrate and a basic metal nitrate and from 10 to 90% by weight of a primary fuel selected from the group consisting of tetrazoles and tetrazole derivatives. The gas generating compositions may further comprise from 4.5 to 33.3% by weight of a secondary fuel selected from the group consisting of guanidines and guanidine derivatives, triazines and triazine derivatives, tetrazoles and tetrazole derivatives, metal carbides, and mixtures thereof. The gas generating compositions may further comprise up to 5% by weight of a secondary oxidizer selected from the group consisting of alkali metal and alkaline earth metal salts of perchloric acid. The gas generating compositions may further comprise up to 10% by weight of an additive selected from the group consisting of calcium stearate, guanidine carbonate, molybdenum trioxide, polyethylene, and mixtures thereof.

### BRIEF DESCRIPTION OF THE DRAWINGS

The drawings are merely exemplary to illustrate structure and certain features that can be used singularly or in combination with other features. The disclosure should not be limited to the implementations shown.

FIG. 1 is cross sectional view of an airbag gas generator comprising a gas generating composition according to various implementations.

### DETAILED DESCRIPTION

### Gas Generating Compositions

Disclosed herein are gas generating compositions, also termed “propellants,” that contain one or more oxidizers, one or more fuels, and optional additives. In certain examples, the disclosed compositions contain a metal nitrate as the oxidizer with a tetrazole and boron carbide as a primary and secondary fuel, respectively. This combination has been found to permit long term stability and autoignition capabilities in a gas generator, also known as an inflator. This improves the versatility when designing inflators, leading to decreased weight, complexity, and cost. The disclosed compositions can also contain a secondary oxidizer, which can limit the formation of undesirable effluent gases such as CO, NOx, and NH3 compared to similar formulations without said secondary oxidizer. Also, as disclosed herein, various additives can be present in the disclosed compositions.

### Oxidizers

In specific examples of the disclosed compositions, the oxidizer is a metal nitrate. In further specific examples, the metal nitrate is potassium nitrate. In further specific examples, the metal nitrate is a basic metal nitrate. A suitable basic metal nitrate can be chosen from a basic copper nitrate, a basic cobalt nitrate, a basic zinc nitrate, a basic manganese nitrate, a basic iron nitrate, a basic molybdenum nitrate, a basic bismuth nitrate, and a basic cerium nitrate. Specific examples of suitable metal nitrates are Cu₂(NO₃)(OH)₃, Cu₃(NO₃)(OH)₅·2H₂O, Co₂(NO₃)(OH)₃, Zn₂(NO₃)(OH)₃, Mn(NO₃)(OH)₂, Fe₄(NO₃)(OH)₁₁·2H₂O, MoO₂(NO₃)₂, Bi(NO₃)(OH)₂ and Ce(NO₃)₃(OH)·H₂O. Among these, basic copper nitrate is preferable.

The metal nitrate component can be present in the disclosed compositions at an amount from 36 to 65% by weight, wherein any value within the range, inclusive of the end points of the range, can be an upper or lower end point of a range of a particular example. In a particular example, the metal nitrate can be present at from 50 to 60%, from 50 to 55%, or from 58 to 65% by weight. In a specific example, the metal nitrate can be present in the composition at 50.4% by weight.

In addition to the metal nitrate, the disclosed compositions can also contain one or more secondary oxidizers. The secondary oxidizers can be chosen from alkali metal and alkaline earth metal salts of perchloric acid. Specific examples of these secondary oxidizers that are suitable for use herein include ammonium perchlorate, sodium perchlorate, potassium perchlorate, magnesium perchlorate and barium perchlorate. In a specific example, the secondary oxidizer is potassium perchlorate.

The secondary oxidizer component can be present in the disclosed compositions at an amount of up to 5% by weight, wherein any value within the range, inclusive of the end points of the range, can be an upper or lower end point of a range of a particular example. In specific examples, the secondary oxidizer component can comprise potassium perchlorate at 5% by weight of the composition.

### Fuels

In specific examples of the disclosed compositions, the primary fuel can be a nitrogen containing organic compound. The nitrogen containing organic compound can be chosen from a tetrazole or a tetrazole derivative chosen from 5,5′-Methylenebis(2H-tetrazole), N-(2H-Tetrazol-5-yl)-2H-tetrazole-5-amine, 5-(2H-tetrazol-5-yl)-2H-tetrazole, and 1H-1,2,3,4-Tetrazol-5-amine. The primary fuel can be present in the composition from 10 to 90% by weight, wherein any value within the range, inclusive of the end points of the range, can be an upper or lower end point of a range of a particular example. In particular examples, the primary fuel can be present at from 25 to 90%, from 20 to 66.6%, from 25 to 30%, or from 10 to 17% by weight. In a specific example, the tetrazole or tetrazole derivative can be present in the composition at 35% by weight.

The primary fuels above are referred to by their IUPAC names. In the rest of this disclosure, they will be referred to by common names. 5,5′-Methylenebis(2H-tetrazole) is known as bi-tetrazole methane or BTM. BTM has the following organic structure:

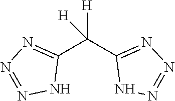 [SMILES: C(c1nnn[nH]1)c1nnn[nH]1]

N-(2H-Tetrazol-5-yl)-2H-tetrazole-5-amine is known as bi-tetrazole amine or BTA. BTA has the following organic structure:

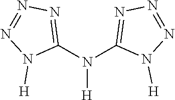 [SMILES: n1n[nH]c(Nc2nnn[nH]2)n1]

5-(2H-tetrazol-5-yl)-2H-tetrazole is known as bi-tetrazole or BHT. BHT has the following organic structure:

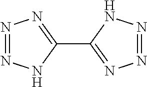

1H-1,2,3,4-Tetrazol-5-amine is known as 5-aminotetrazole or 5AT. 5AT has the following organic structure:

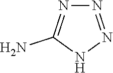

The secondary fuel can be another nitrogen containing organic compound or a metal carbide. The use of a secondary fuel can improve auto-ignition performance (lower temperature), burn rates, and combustion effluent gas composition, for example. In specific examples, the secondary fuel can be guanidine or a guanidine derivative. The guanidine derivative can be chosen from nitroguanidine, guanidine nitrate, aminoguanidine, aminoguanidine nitrate, and aminoguanidine hydrogen carbonate. In a preferred example, the guanidine derivative is guanidine nitrate. In other specific examples, the secondary fuel can be triazine or a triazine derivative. In a preferred example, the triazine derivative is melamine nitrate. In other specific examples, the secondary fuel can be tetrazole or a tetrazole derivative. In a preferred example, the tetrazole derivative is 5-Amino-1,2,3,4-tetrazole potassium salt, also known as potassium 5AT or K5AT. In a preferred example where the secondary fuel is a metal carbide, the metal carbide is boron carbide. In specific examples, the composition may include one or more secondary fuels.

The secondary fuel can be present in the disclosed compositions at an amount from 4.5 to 33.3% by weight, wherein any value within the range, inclusive of the end points of the range, can be an upper or lower end point of a range of a particular example. In particular examples, the secondary fuel can be present at from 5 to 7%, from 5 to 15%, from 13 to 25%, from 9.5 to 15.2%, from 4.5 to 33.3%, from 10 to 13.3%, from 6.3 to 15%, or 25% by weight, In a specific example, the secondary fuel, chosen as boron carbide, can be present in the composition at 13.3% by weight.

### Additives

The disclosed compositions can also optionally contain one or more additives. For examples, additives can provide a variety of features: cooler gas temperature, slagging, improved effluents, improved binding, burn rate moderation, anti-caking, and improved powder flow through lubrication. Additives can include calcium stearate, guanidine carbonate, molybdenum trioxide, and polyethylene, any of which may be used alone or in combination with each other in particular examples. For example, the disclosed compositions can contain up to 10% by weight of an additive(s), wherein any value up to and including 10% can be an upper or lower end point of a range of a particular example. In a specific example, polyethylene can be present at 1% by weight of the composition and molybdenum trioxide can be present at 5% by weight of the same composition.

### Particle Size

It can be desired that certain, or all, of the components of the disclosed compositions, or the composition itself, can be provided in small particles sizes, e.g., 360 μm or less. For example, BTM can be used that is less than 200 μm. Obtaining small particle sizes can be achieved by milling, e.g., with vibratory or jet mills. The particular size that is used can depend on the particular component, application, and composition. In certain examples, the primary fuel is reduced in particle size to a size of 172 to 360 μm. When referring to particle size, it should be understood there is a distribution of particle sizes throughout any given sample of a component or composition. A specific particle size listed in μm in this disclosure refers to the particle size known as D90, meaning 90% of the distribution of particle sizes has a diameter less than the number shown, assuming every particle is a sphere. For example, a particle size of 100 μm means that 90% of the particles of the component or composition have a diameter less than 100 μm, wherein the particles are assumed to be perfect spheres.

### Articles

The disclosed gas generating compositions can be prepared by mixing the various components disclosed herein in the described amounts. For example, the components can be ground separately or together in a pin mill, vibratory mill, or jet mill. The milled powders can be blended in a ribbon blender. The blended powder can be compacted and granulated on a roll compactor and subsequent in-line granulator, and the granules compressed on a traditional tablet press.

The pressed, molded articles of the gas generating compositions disclosed herein can be in a desired shape, for example in the form of a cylinder, a single-perforated cylinder, a perforated cylinder, a doughnut, or a pellet. The molded article can also be produced by adding water or an organic solvent to the gas generating compositions, then mixing them, and extrusion-molding the mixture (molded product in the form of a single-perforated cylinder or a perforated cylinder) or compression-molding the mixture (molded product in the form of a pellet) by a tableting machine.

### Methods of Use

The disclosed compositions can be used in powdered form or in molded form. The molded articles can be introduced in loose bulk or in oriented fashion into appropriate pressure-proof containers. They are ignited according to conventional methods with the aid of initiator charges or thermal charges wherein the thus-formed gases, optionally after flowing through a suitable filter, lead to inflation of the airbag system within fractions of a second. The compositions disclosed herein are especially suited for so-called airbags, impact bags which are utilized in automotive vehicles for occupants' protection. In case of vehicle impact, the airbag must fill up within a minimum time period with gas quantities of about 50 to 300 liters, depending on system and automobile size. The disclosed compositions are likewise suitable for use in seat belt-tightening devices, for example retractors or pretensioners. Further disclosed are inflators comprising the disclosed gas generating compositions. The disclosed inflators can be steel or aluminum or plastic, for example.

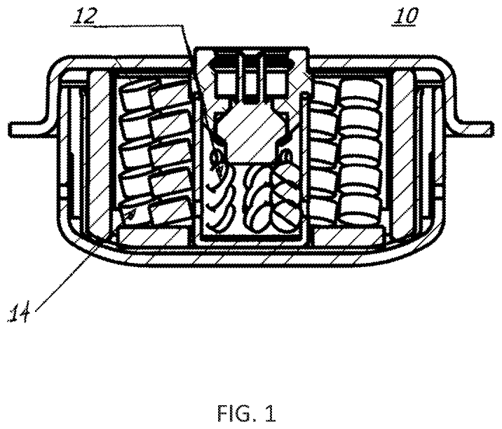

As shown in FIG. 1, exemplary inflator 10 comprises a single ignition chamber comprising a main gas generant 14. The inflator 10 also comprises a booster chamber comprising booster gas generant 12. When the inflator 10 is deployed, booster gas generant 12 is ignited and thus causes ignition of the main gas generant 14, therefore providing inflation gas to a connected airbag. The gas generating compositions described herein may be used for either the booster gas generant 12 or the main gas generant 14, or both. Preferably, the gas generating compositions described herein are used as the booster gas generant 12.

### EXAMPLES

The following examples are set forth below to illustrate the methods, compositions, and results according to the disclosed subject matter. These examples are not intended to be inclusive of all aspects of the subject matter disclosed herein, but rather to illustrate representative methods, compositions, and results. These examples are not intended to exclude equivalents and variations of the present disclosure, which are apparent to one skilled in the art.

### BTM Examples

Example 1: A composition was prepared comprising 60% by weight of potassium nitrate and 40% by weight of BTM. The composition of Example 1 had an autoignition temperature of 183-186 degrees Celsius and a weight loss after spending 17 days at 107 degrees Celsius of 0.03% by weight. The BOE or Bruceton impact sensitivity of this composition (tested as known in the art and similarly determined in the examples incorporating such data) was 2.5 inches. The friction sensitivity as measured by the BAM friction test (tested as known in the art and similarly determined in the examples containing this data) was 288 N.

Example 2: A composition was prepared comprising 50% by weight of potassium nitrate, 35% by weight of BTM, and 15% by weight of guanidine nitrate. The composition of Example 2 had an autoignition temperature of 175-180 degrees Celsius and a weight loss after spending 17 days at 107 degrees Celsius of 0.08% by weight.

Example 3: A composition was prepared comprising 50.4% by weight of potassium nitrate, 30% by weight of BTM, 6.3% by weight of guanidine nitrate, and 13.3% by weight of boron carbide. The composition of Example 3 had an autoignition temperature of 170-175 degrees Celsius and a weight loss after spending 17 days at 107 degrees Celsius of 0.23% by weight. The impact sensitivity of this composition was 1.6 inches. The friction sensitivity was 168 N.

Example 4: A composition was prepared comprising 50% by weight of potassium nitrate, 40% by weight of BTM, and 10% by weight of boron carbide. The composition of Example 4 had an autoignition temperature of 185-190 degrees Celsius. The impact sensitivity of this composition was 1.7 inches. The friction sensitivity was 168 N.

Example 5: A composition was prepared comprising 90% by weight of BTM and 10% by weight of guanidine carbonate. The impact sensitivity of this composition was 1.5 inches. The friction sensitivity was 324 N.

Example 6: A composition was prepared comprising 60% by weight of potassium nitrate, 30% by weight of BTM, and 10% by weight of guanidine carbonate. The impact sensitivity of this composition was 2.4 inches. The friction sensitivity was 160 N.

Example 7: A composition was prepared comprising 60% by weight of potassium nitrate, 35% by weight of BTM, and 5% by weight of calcium stearate. The impact sensitivity of this composition was 2.4 inches. The friction sensitivity was greater than 360 N.

Example 8: A composition was prepared comprising 50% by weight of basic copper nitrate and 50% by weight of BTM. The impact sensitivity of this composition was 2.2 inches. The friction sensitivity was 168 N.

Example 9: A composition was prepared comprising 50% by weight of basic copper nitrate, 25% by weight of BTM, and 25% by weight of guanidine nitrate. The impact sensitivity of this composition was 2.2 inches. The friction sensitivity was 252 N.

Example 10: A composition was prepared comprising 50% by weight of basic copper nitrate, 25% by weight of BTM, and 25% by weight of melamine nitrate. The impact sensitivity of this composition was 1.2 inches. The friction sensitivity was 324 N.

### BTA Examples

Example 11: A composition was prepared comprising 65% by weight of potassium nitrate and 35% by weight of BTA. The composition of Example 11 had an autoignition temperature of 250 degrees Celsius. The impact sensitivity of this composition was greater than 15 inches. The friction sensitivity was 216 N.

Example 12: A composition was prepared comprising 65% by weight of potassium nitrate, 30% by weight of BTA, and 5% by weight of guanidine nitrate. The composition of Example 12 had an autoignition temperature of greater than 220 degrees Celsius. The impact sensitivity of this composition was 1.5 inches. The friction sensitivity was 240 N.

Example 13: A composition was prepared comprising 60% by weight of potassium nitrate, 30% by weight of BTA, and 10% by weight of guanidine nitrate. The composition of Example 13 had an autoignition temperature of 170-173 degrees Celsius.

Example 14: A composition was prepared comprising 50% by weight of potassium nitrate, 35% by weight of BTA, and 15% by weight of guanidine nitrate. The composition of Example 14 had an autoignition temperature of 168-170 degrees Celsius.

Example 15: A composition was prepared comprising 60% by weight of potassium nitrate, 20% by weight of BTA, and 20% by weight of guanidine nitrate. The composition of Example 15 had an autoignition temperature of 166-168 degrees Celsius

Example 16: A composition was prepared comprising 50.4% by weight of potassium nitrate, 30% by weight of BTA, 6.3% by weight of guanidine nitrate, and 13.3% by weight of boron carbide. The composition of Example 16 had an autoignition temperature of 182 degrees Celsius and a weight loss after spending 17 days at 107 degrees Celsius of 0.40% by weight. The impact sensitivity of this composition was 1 inch. The friction sensitivity was 168 N.

Example 17: A composition was prepared comprising 36% by weight of potassium nitrate, 50% by weight of BTA, 4.5% by weight of guanidine nitrate, and 9.5% by weight of boron carbide. The composition of Example 17 had an autoignition temperature of 192-200 degrees Celsius.

Example 18: A composition was prepared comprising 57.6% by weight of potassium nitrate, 20% by weight of BTA, 7.2% by weight of guanidine nitrate, and 15.2% by weight of boron carbide. The composition of Example 18 had an autoignition temperature of greater than 210 degrees Celsius.

### BHT Examples

Example 19: A composition was prepared comprising 50% by weight of potassium nitrate, 25% by weight of BHT, and 25% by weight of guanidine nitrate. The composition of Example 19 had an autoignition temperature of 180-182 degrees Celsius. The impact sensitivity of this composition was greater than 15 inches. The friction sensitivity was 160 N.

Example 20: A composition was prepared comprising 55% by weight of potassium nitrate, 30% by weight of BHT, and 15% by weight of guanidine nitrate. The composition of Example 20 had an autoignition temperature of 172-175 degrees Celsius. The impact sensitivity of this composition was 5.5 inches. The friction sensitivity was 160 N.

### 5AT Examples

Example 21: A composition was prepared comprising 58% by weight of potassium nitrate, 17% by weight of 5AT, 7% by weight of K5AT, 7% by weight of boron carbide, 5% by weight of molybdenum trioxide, 5% by weight of potassium perchlorate, and 1% by weight of polyethylene. The composition of Example 21 had an autoignition temperature of 183-187 degrees Celsius. The impact sensitivity of this composition was 3.7 inches.

Example 22: A composition was prepared comprising 60% by weight of potassium nitrate, 17% by weight of 5AT, 7% by weight of K5AT, 10% by weight of boron carbide, 5% by weight of molybdenum trioxide, and 1% by weight of polyethylene. The composition of Example 22 had an autoignition temperature of 183-185 degrees Celsius. The impact sensitivity of this composition was 3.2 inches.

Example 23: A composition was prepared comprising 65% by weight of potassium nitrate, 17% by weight of 5AT, 7% by weight of K5AT, 5% by weight of boron carbide, 5% by weight of molybdenum trioxide, and 1% by weight of polyethylene. The composition of Example 23 had an autoignition temperature of 183-185 degrees Celsius. The impact sensitivity of this composition was 5.4 inches.

Example 24: A composition was prepared comprising 65% by weight of potassium nitrate, 10% by weight of 5AT, 5% by weight of K5AT, 15% by weight of boron carbide, and 5% by weight of molybdenum trioxide. The composition of Example 24 had an autoignition temperature of 192-195 degrees Celsius. The impact sensitivity of this composition was 3.2 inches.

A number of implementations have been described. The description in the present disclosure has been presented for purposes of illustration but is not intended to be exhaustive or limited to the implementations disclosed. It will be understood that various modifications and variations will be apparent to those of ordinary skill in the art and may be made without departing from the spirit and scope of the claims. Accordingly, other implementations are within the scope of the following claims. The implementations described were chosen in order to best explain the principles of the gas generating composition and its practical application, and to enable others of ordinary skill in the art to understand the gas generating composition for various implementations with various modifications as are suited to the particular use contemplated.

The terminology used herein is for the purpose of describing particular implementations only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, operations, elements, and/or components, but do not preclude the presence or addition of one or more other features, operations, elements, components, and/or groups thereof.

1-4. (canceled)

5. A gas generating composition comprising:
potassium nitrate;
boron carbide;
from 20 to 50% by weight of a bi-tetrazole; and
from 4.5 to 7.2% by weight of guanidine nitrate;
wherein the gas generating composition has an autoignition temperature of 200° C. or less.

6. The gas generating composition of claim 5, wherein the potassium nitrate is present from 36 to 57.6% by weight.

7. The gas generating composition of claim 5, wherein the boron carbide is present from 9.5 to 15.2% by weight.

8. The gas generating composition of claim 6, wherein the boron carbide is present from 9.5 to 15.2% by weight.

9. The gas generating composition of claim 5, wherein the bi-tetrazole is BTM.

10. The gas generating composition of claim 5, wherein the bi-tetrazole is BTA.

11. A gas generating composition comprising:
potassium nitrate;
from 25 to 30% by weight of a bi-tetrazole; and
from 15 to 25% by weight of guanidine nitrate;
wherein the gas generating composition has an autoignition temperature of 190° C. or less.

12. The gas generating composition of claim 11, wherein the potassium nitrate is present from 50 to 55% by weight.

13. The gas generating composition of claim 11, wherein the bi-tetrazole is BHT.

14. A gas generating composition consisting essentially of:
potassium nitrate;
boron carbide;
from 20 to 50% by weight of a bi-tetrazole; and
from 4.5 to 7.2% by weight of guanidine nitrate;
wherein the gas generating composition has an autoignition temperature of 200° C. or less.

15. The gas generating composition of claim 14, wherein the potassium nitrate is present from 36 to 57.6% by weight.

16. The gas generating composition of claim 14, wherein the boron carbide is present from 9.5 to 15.2% by weight.

17. The gas generating composition of claim 15, wherein the boron carbide is present from 9.5 to 15.2% by weight.

18. The gas generating composition of claim 14, wherein the bi-tetrazole is BTM.

19. The gas generating composition of claim 14, wherein the bi-tetrazole is BTA.
